(19) United States
(12) Patent Application Publication
(10) Pub. No.: US 2013/0130199 A1
(43) Pub. Date: May 23, 2013

(54) Apparatus and Method for Dental Seating

(71) Applicant: Kenneth Palm, (US)

(72) Inventor: Kenneth Palm, (US)

(21) Appl. No.: 13/443,812

(22) Filed: Apr. 10, 2012

(30) Foreign Application Priority Data
Nov. 17, 2011 (US) PCT/US11/61289

(51) Int. Cl. A61C 8/00

(52) U.S. Cl. 433/173

(57) ABSTRACT

An apparatus and method for a consistent and efficient way to seat dental prosthetics in any area of a patient's mouth is disclosed. The present invention comprises an apparatus and method to allow for easy and efficient seating of Dental Prosthetics by use of an inventive dental seater apparatus (“Dental Seater”). The present invention addresses all of the above mentioned deficiencies of the conventional methods. In particular, the present invention increases the predictability and utility of seating results by having the Dental Seater fabricated using preferred firm materials, including without limitation any of the currently used dental materials. In addition, the present invention can be used in any part of the mouth, and in either arch (maxilla or mandible), and with any currently used Dental Prosthetics.

### CLAIM OF PRIORITY

This application claims the benefit and priority of U.S. patent application No. 61/414,466, filed Nov. 17, 2010.

### BACKGROUND OF THE INVENTION

The present invention relates to the final cementation of dental crowns, bridges, inlays, and/or onlays (“Dental Prosthetics”). Currently, seating Dental Prosthetics in a patient mouth is a time consuming and inconsistent procedure, where results are highly dependant on both the skill of the dental professional administering the procedure, as well as the patient's compliance with the dental professional's instructions. More specifically, Dental Prosthetics are seated by most dentists using cotton rolls (which are generally of different consistencies, materials, etc.), tongue depressors, or plastic or wooden bite sticks. All of the above conventional materials produce seating results lacking uniformity, consistency, predictability and/or utility.

### FIELD OF THE INVENTION

The present invention relates generally to dentistry. More specifically, but without limitation, the present invention relates to a dental apparatus and method to be used to aid in implanting Dental Prosthetics.

### SUMMARY OF THE INVENTION

The present invention provides an apparatus and method for a consistent and efficient way to seat Dental Prosthetics in any area of a patient's mouth. The present invention comprises an apparatus and method to allow for easy and efficient seating of Dental Prosthetics by use of an inventive dental seater apparatus (“Dental Seater”). The present invention addresses all of the above mentioned deficiencies of the conventional methods. In particular, the present invention increases the predictability and utility of seating results by having the Dental Seater fabricated using preferred firm materials, including without limitation any of the currently used dental materials. In addition, the present invention can be used in any part of the mouth, and in either arch (maxilla or mandible), and with any currently used Dental Prosthetics.

### BRIEF DESCRIPTION OF THE DRAWINGS

The present invention is illustrated by way of example, and not limitation, in the accompanying figures, in which like references indicate similar elements, and in which:

FIG. 1A illustrates a first exemplary embodiment of the present invention with reference to a patient's month, where the dental seater includes grooves to limit displacement of the dental seater;

FIG. 1B illustrates the first exemplary embodiment of FIG. 1B in isolation;

FIG. 2 illustrates a second embodiment of the present invention, where the dental seater does not include the grooves of FIG. 1A and is designed to align with each tooth;

FIG. 3A illustrates a third embodiment of the present invention with reference to a patient's month, specifically for use with a molar;

FIG. 3B illustrates the third embodiment of FIG. 3A in isolation;

FIG. 4 illustrates a fourth embodiment of the present invention;

FIG. 5 illustrates a fifth embodiment of the present invention;

FIG. 6 illustrates a sixth embodiment of the present invention;

FIG. 7 illustrates a seventh embodiment of the present invention;

FIG. 8 illustrates an eight embodiment of the present invention;

FIG. 9 illustrates a ninth embodiment of the present invention, reference to a patient's month;

FIG. 10 illustrates a tenth embodiment of the present invention; and

FIG. 11 illustrates the ninth embodiment of FIG. 9 in isolation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

The following description is of the best presently contemplated mode of carrying out the present invention. This description is not to be taken in a limiting sense, but is made merely for the purpose of describing the general principles of the invention. The scope of the invention should be determined by referencing the appended claims.

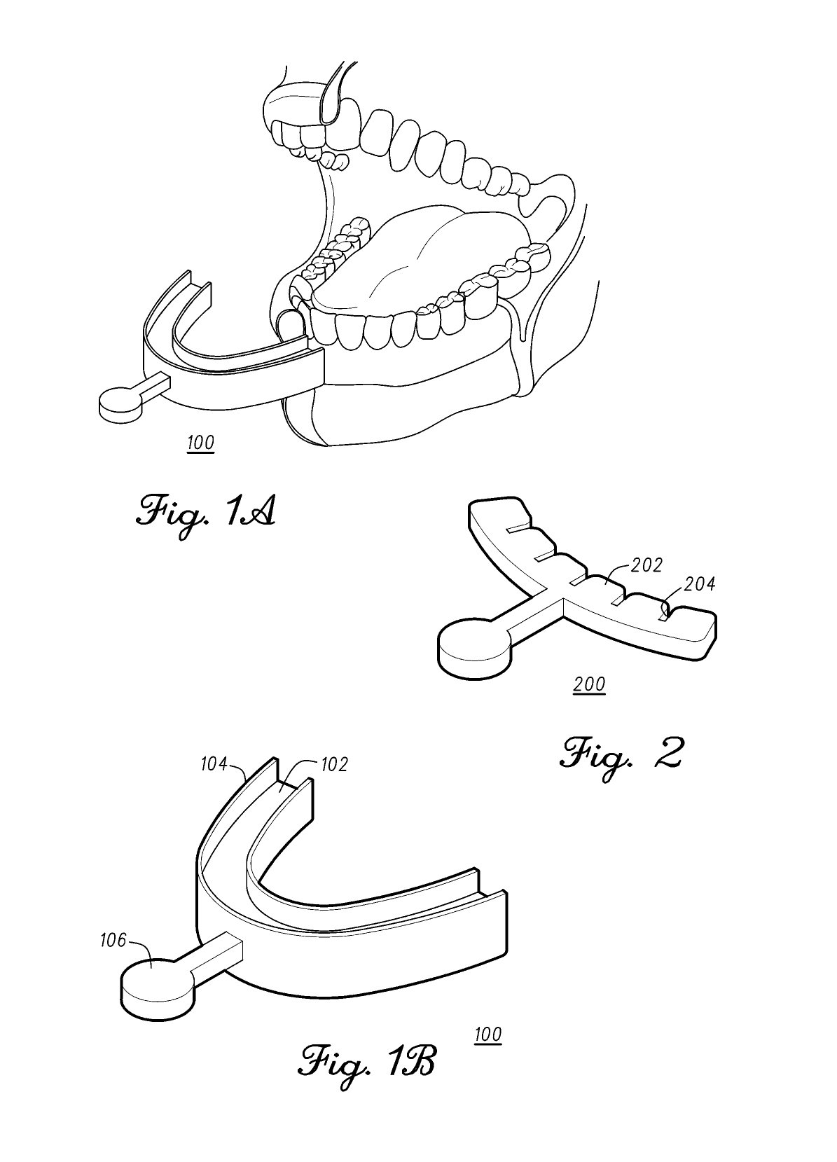

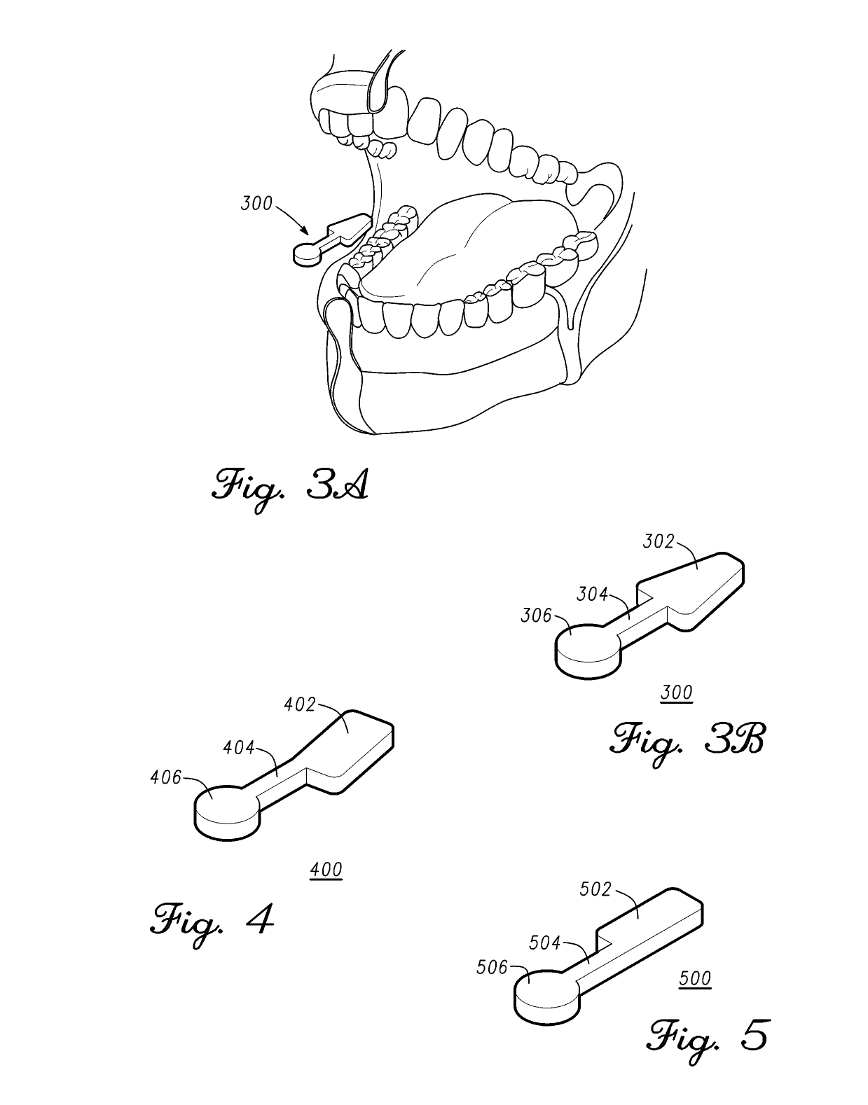

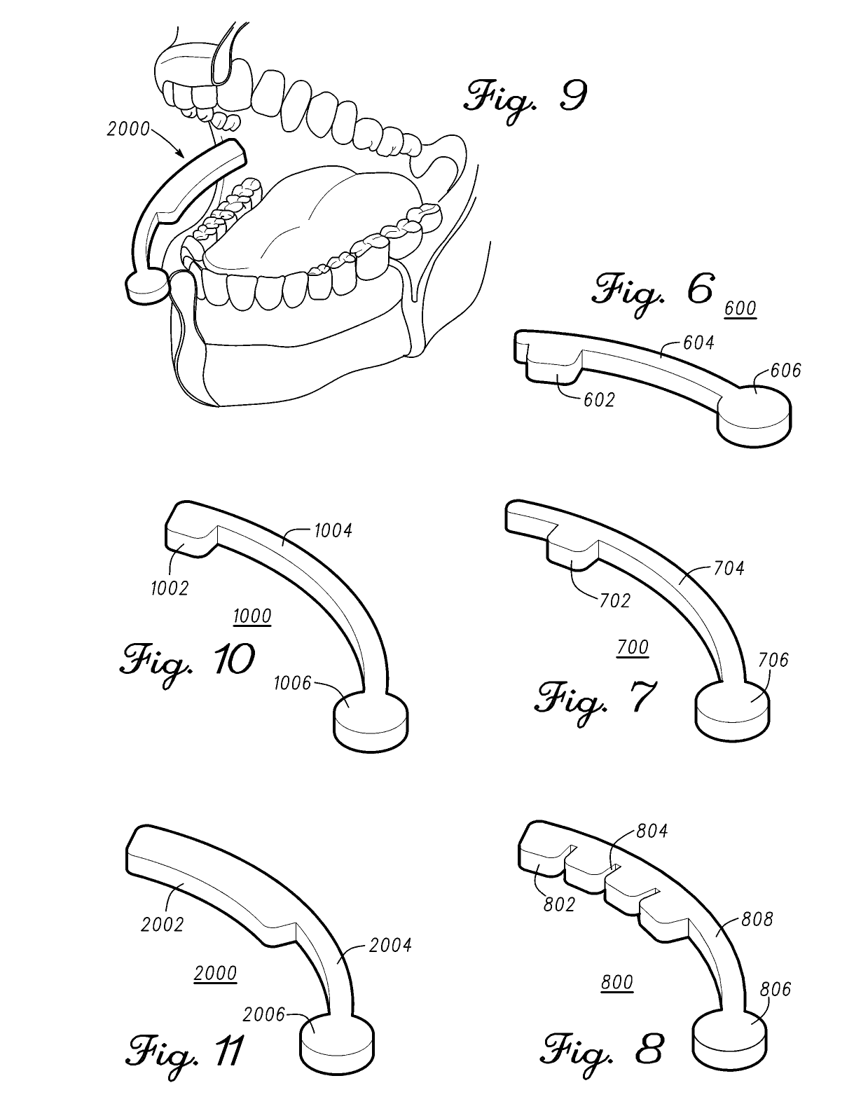

Referring to the figures (“FIGS.”), the present invention is depicted in accordance with multiple exemplary embodiments. Referring to FIGS. 1A and 1B, a Dental Seater 100 is shown. Dental Seater 100 is preferably a relatively stable form, with a handle 106, that is designed to be placed between the upper and lower teeth as the patient bites down on the Dental Prosthetic. Dental Seater 100 may optionally have a groove 102 with side walls 104, to prevent displacement of the Dental Seater 100, when in a patient's month. Such groove 102 may be fabricated on the upper, lower, or both sides of the Dental Seater 100. While this invention may be fabricated with various materials, in accordance with a preferred embodiment, this invention comprises a firm silicone material. While being firmer than a cotton ball, the Dental Seater 100 of the present invention may be fabricated of multiple types of materials ranging from “absolutely firm” to “firm with some flexibility”.

Regarding dimensions, the Dental Seater 100 may be a variety of sizes for various mouth sizes. In an exemplary embodiment, the Dental Seater 100 is approximately three inches long, ¼ inches wide, and ¼ inches thick.

In accordance with an exemplary method of the present invention, the present inventive method comprises (described with reference to a crown):

(1) once it is ready to be cemented, placing cement into the crown;

(2) placing the crown on the prepared tooth in the correct position;

(3) placing the Dental Seater 100 directly above the tooth (if lower tooth), or under the tooth (if upper tooth), and have the patient slowly by firmly bite down until the crown is seated to the margin;

(4) having the patient open as the dental professional removes the Dental Seater 100 to check the occlusion; and

(5) re-inserting the Dental Seater 100 and having the patient close again firmly until the excess cement is ready to be removed.

While seating dental crowns, bridges, inlays, and/or onlays are common uses of the present invention, the present invention has multiple alternative uses and variants. Some variants include, without limitation, an anterior Dental Seater and Posterior Dental Seater, and an anatomical Dental Seater (similar to FIG. 1) versus the flat occlusion Dental Seater. Further, in accordance with alternative exemplary embodiments, the Dental Seater may be used to insert new dentures and simultaneously diagnose and evaluate sore spots.

Hence, numerous alternative embodiments can be realized. To account for such varied conditions, the present invention provides such alternative exemplary embodiments.

Referring to FIG. 2, the present invention provides a Dental Seater 200 with elements 202 designed to align with each tooth, and spacing 204.

Referring to FIG. 3A and 3B, the present invention provides a Dental Seater 300 with an element designed to align with one molar. As with all the embodiments of the present invention, Dental Seater 300 features a handle 306 and extension 304.

Referring to FIG. 4, the present invention provides a Dental Seater 400 with an element designed to align with teeth on one side of a patient's month. As with all the embodiments of the present invention, Dental Seater 400 features a handle 406 and extension 404.

Referring to FIG. 5 (which is a slight variant from FIG. 4), the present invention provides a Dental Seater 500 with an element designed to align with teeth on one side of a patient's month. As with all the embodiments of the present invention, Dental Seater 500 features a handle 506 and extension 504.

Referring to FIG. 6, the present invention provides a Dental Seater 600 with an angled element 602 designed to align with one tooth on one side of a patient's month. As with all the embodiments of the present invention, Dental Seater 600 features a handle 606 and extension 604.

Referring to FIG. 7, the present invention provides a Dental Seater 700 with an angled element 702 designed to align with one tooth on one side of a patient's month. As with all the embodiments of the present invention, Dental Seater 700 features a handle 706 and extension 704.

Referring to FIG. 8, the present invention provides a Dental Seater 800 with an angled element 802 designed to align with selected teeth on one side of a patient's month. As with all the embodiments of the present invention, Dental Seater 800 features a handle 806 and extension 804.

Referring to FIG. 10, the present invention provides a Dental Seater 1000 with an angled element 1002 designed to align with a tooth on one side of a patient's month. As with all the embodiments of the present invention, Dental Seater 1000 features a handle 1006 and extension 1004.

Referring to FIGS. 9 and 11, the present invention provides a Dental Seater 2000 with an angled element 2002 designed to align with teeth on one side of a patient's month. As with all the embodiments of the present invention, Dental Seater 2000 features a handle 2006 and extension 2004.

While the invention disclosed herein has been described by means of specific embodiments and applications thereof, other modifications, variations, and arrangements of the present invention may be made in accordance with the above teachings other than as specifically described to practice the invention within the spirit and scope defined by the following claims.

What is claimed is:

1. An apparatus, comprising:
a first surface for interfacing with at least one dental prosthetic; and
a second surface for interfacing with teeth on the opposing side of said at least one dental prosthetic.

2. The apparatus of claim 1 further comprising a handle.

3. The apparatus of claim 1 further comprising an extension.

4. The apparatus of claim 3 further comprising a curved extension.

4. The apparatus of claim 1 further comprising at least one groove on the opposing side of said at least one dental prosthetic.

5. The apparatus of claim 1 further comprising at least one groove on the side of said at least one dental prosthetic.

6. The apparatus of claim 1 further comprising one grooves on each side of the apparatus.

7. The apparatus of claim 1 further comprising spaces as to align with selected teeth.

8. The apparatus of claim 1 further comprising a first surface to align with multiple teeth.

9. The apparatus of claim 1 further comprising a first surface to align one teeth.

10. The apparatus of claim 1 further comprising a second surface to align with multiple teeth.

11. The apparatus of claim 1 further comprising a second surface to align with one teeth.

12. A method for seating at least one dental prosthetic, comprising the steps of:
(a) placing cement into at least one dental prosthetic;
(b) placing said at least one dental prosthetic in the correct position;
(c) placing an apparatus directly above said at least one dental prosthetic (if lower tooth), or under said at least one dental prosthetic (if upper tooth); and
(d) closing until said at least one dental prosthetic is seated to the margin.

13. The method of claim 12 further comprising the step of:
(e) removing said apparatus to check the occlusion;

14. The method of claim 13 further comprising the step of:
(f) re-inserting said apparatus.

15. The method of claim 14 further comprising the step of:
(g) close again until excess cement from said at least one dental prosthetic is ready to be removed.

16. A method for seating at least one dental prosthetic, comprising the steps of:
(a) placing said at least one dental prosthetic in the correct position;
(b) placing an apparatus directly above said at least one dental prosthetic (if lower tooth), or under said at least one dental prosthetic (if upper tooth); and
(c) closing until said at least one dental prosthetic is seated to the margin.
